(19) United States
(12) Patent Application Publication
(10) Pub. No.: US 2022/0319512 A1
(43) Pub. Date: Oct. 6, 2022

(54) LANGUAGE INFERENCE APPARATUS, LANGUAGE INFERENCE METHOD, AND PROGRAM

(71) Applicant: NEC Corporation, Minato-ku, Tokyo (JP)

(72) Inventor: Shuji KOMEIJI, Tokyo (JP)

(73) Assignee: NEC Corporation, Minato-ku, Tokyo (JP)

(21) Appl. No.: 17/639,976

(22) PCT Filed: Sep. 7, 2020
(86) PCT No.: PCT/JP2020/033723

§ 371 Date: Mar. 3, 2022

(30) Foreign Application Priority Data
Sep. 10, 2019 (JP) 2019-164404

(51) Int. Cl. G10L 15/22; G10L 15/00; G06F 40/58

(52) U.S. Cl. CPC G10L 15/22; G10L 15/005; G06F 40/58

(57) ABSTRACT

A language inference apparatus (100) includes an acquisition unit (102) that acquires nationality information, a selection unit (104) that selects a language inference engine by using the acquired nationality information, and a determination unit (106) that determines a language used by a speaker, by analyzing voice information of the speaker using the selected language inference engine (110).

### TECHNICAL FIELD

The present invention relates to a language inference apparatus, a language inference method, and a program.

### BACKGROUND ART

In recent years, due to an increase in foreign immigrants and foreign travelers, a demand for communication via a translator or an interpreter has been increasing.

Patent Document 1 describes a voice communication apparatus that outputs and inputs, when an ID card in which an individual identification number is written is inserted, a voice as a terminal dedicated for the owner of the ID card. The ID card stores a voice or a particular glossary a mother tongue of an owner. The terminal dedicated for the owner can be controlled when a voice is collated in a state where the ID card is inserted.

Patent Document 2 describes an apparatus that generates an exported duty-free commodity purchase record sheet at product purchase in a duty-free shop. In the apparatus, a plurality of pieces of language-by-language report information are stored in association with a country-by-country code, and when a country-by-country code is read from a storage medium, language-by-language report information being associated with the country-by-country code is acquired, and information to be reported is printed out and output by using the language-by-language report information.

Patent Document 3 describes reading attribute data indicating a nationality of a recognition target person from a passport, translating a message into a language being related to the read nationality, and thereby acquiring a guidance in the language being related to the nationality.

### RELATED DOCUMENT

### Patent Document

[Patent Document 1] Japanese Patent Application Publication No. H03-150927
[Patent Document 2] Japanese Patent Application Publication No. 2017-4333
[Patent Document 3] Japanese Patent Application Publication No. 2019-40642

### SUMMARY OF THE INVENTION

### Technical Problem

With advance of internationalization, visiting foreigners are diversified. Thus, the number of languages needing translation has increased, and time is required for determining a language spoken by a foreign speaker.

The present invention has been made in view of the above circumstances, and an object thereof is to provide a technique for performing language inference efficiently and accurately.

### Solution to Problem

In order to solve the problem described above, each aspect of the present invention adopts each of configurations below.

A first aspect relates to a language inference apparatus.

A first language inference apparatus according to the first aspect includes:

an acquisition unit that acquires nationality information;

a selection unit that selects a language inference engine by using the acquired nationality information; and

a determination unit that determines a language used by a speaker, by analyzing voice information of the speaker using the selected language inference engine.

A second language inference apparatus according to the first aspect includes:

an acquisition unit that acquires nationality information;

a selection unit that selects a candidate for a language of a language inference target by using the acquired nationality information; and

a determination unit that determines a language used by a speaker from the selected candidate, by analyzing voice information of the speaker using a language inference engine.

A second aspect relates to a language inference method executed by at least one computer.

A first language inference method according to the second aspect includes:

by a language inference apparatus,

acquiring nationality information;

selecting a language inference engine by using the acquired nationality information; and

determining a language used by a speaker, by analyzing voice information of the speaker using the selected language inference engine.

A second language inference method according to the second aspect includes:

by a language inference apparatus,

acquiring nationality information;

selecting a candidate for a language of a language inference target by using the acquired nationality information; and

determining a language used by a speaker from the selected candidate, by analyzing voice information of the speaker using a language inference engine.

Note that, another aspect of the present invention may be a program that causes at least one computer to execute the method according to the second aspect, or may be a computer-readable storage medium recording such a program. The storage medium includes a non-transitory tangible medium.

The computer program includes a computer program code that causes, when executed by a computer, the computer to implement the language inference method on a language inference apparatus.

Note that, any combination of the above components, or a conversion of an expression of the present invention between a method, an apparatus, a system, a storage medium, a computer program, and the like is also effective as an aspect of the present invention.

Moreover, each of various kinds of components of the present invention does not necessarily need to be an individually independent existence, and may be in such a form that a plurality of components are formed as one member, one component is formed of a plurality of members, a certain component is a part of another component, or a part of a certain component overlaps a part of another component.

Moreover, although a plurality of procedures are described in order in each of the method and the computer program of the present invention, an order of the descriptions does not limit an order of executing the plurality of procedures. Thus, when each of the method and the computer program of the present invention is implemented, an order of the plurality of procedures can be changed to an extent that causes no problem in terms of content.

Furthermore, a plurality of procedures of each of the method and the computer program of the present invention are not limited to being executed at individually differing timings. Thus, a plurality of procedures may be in such a form that, during execution of a certain procedure, another procedure occurs, or an execution timing of a certain procedure and an execution timing of another procedure partly or entirely overlap each other.

### Advantageous Effects of Invention

Each of the aspects described above can provide a technique for performing language inference efficiently and accurately.

### BRIEF DESCRIPTION OF THE DRAWINGS

FIG. 1 is a block diagram illustrating a conceptual configuration example of a multilingual support communication system according to an example embodiment of the present invention.

FIG. 2 is a functional block diagram logically illustrating a configuration of a language inference apparatus according to an example embodiment of the present invention.

FIG. 3 is a block diagram illustrating a hardware configuration of a computer that achieves a language inference apparatus according to an example embodiment of the present invention.

FIG. 4 is a flowchart illustrating one example of an operation of a language inference apparatus according to the present example embodiment.

FIG. 5 is a diagram illustrating one example of a data structure of a country-by-country language inference engine table.

FIG. 6 is a functional block diagram illustrating a logical configuration example of a language inference apparatus according to the present example embodiment.

FIG. 7 is a flowchart illustrating one example of an operation of the language inference apparatus according to the present example embodiment.

FIG. 8 is a functional block diagram illustrating a logical configuration example of a language inference apparatus according to the present example embodiment.

FIG. 9 is a diagram illustrating one example of a screen displayed by an output unit.

FIG. 10 is a flowchart illustrating an operation example of the language inference apparatus according to the present example embodiment.

### DESCRIPTION OF EMBODIMENTS

Hereinafter, an example embodiment of the present invention is described by using the drawings. Note that, in all of the drawings, a similar component is assigned with a similar reference sign, and description thereof is omitted, as appropriate. In each of the following diagrams, a configuration of a part that does not concern essence of the present invention is omitted, and is not illustrated.

In the example embodiment, “acquisition” includes at least one of fetching, by an own apparatus, data or information stored in another apparatus or a storage medium (active acquisition), and inputting, into an own apparatus, data or information output from another apparatus (passive acquisition). Examples of active acquisition include requesting or inquiring of the another apparatus and receiving a reply thereof, accessing the another apparatus or the storage medium and reading, and the like. Moreover, an example of passive acquisition includes receiving information given by distribution (or transmission, push notification, or the like), and the like. Further, “acquisition” may include selecting and acquiring from received data or information, or selecting and receiving distributed data or information.

### First Example Embodiment

### <System Outline>

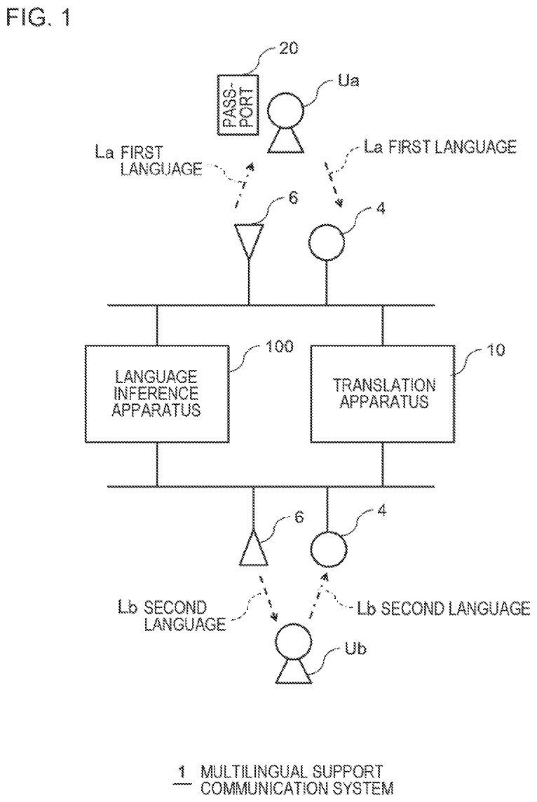

FIG. 1 is a block diagram illustrating a conceptual configuration example of a multilingual support communication system 1 according to an example embodiment of the present invention. The multilingual support communication system 1 includes a language inference apparatus 100 and a translation apparatus 10. The language inference apparatus 100 and the translation apparatus 10 may be integrated, i.e., physically the same hardware.

The multilingual support communication system 1 infers, by using the language inference apparatus 100, a first language used by a visitor (first speaker Ua), when, for example, a procedure is performed at a window of customs, immigration check, quarantine, or the like of an international airport. Then, the translation apparatus 10 performs mutual translation between a first language La of the determined speaker Ua and a second language Lb used by a colloquist (second speaker Ub) such as an officer at a window, or the like.

The translation apparatus 10 inputs, via a voice input apparatus such as a microphone 4, speech voices of the first speaker Ua and the second speaker Ub. Although the microphone 4 is provided for each of both the speakers in a configuration in FIG. 1, the present invention is not limited thereto. One microphone 4 having directivities in at least two directions may be provided. Moreover, a voice output apparatus such as a speaker 6 is also provided for each of both the speakers in the configuration in FIG. 1, there may be at least one voice output apparatus, or two or more speakers 6 may be included. In still another example, a portable terminal may be used and replace each of the voice input and output apparatuses (the microphone 4 and the speaker 6).

Then, after recognizing that a speech voice of the first speaker Ua input via the microphone 4 is in the first language La, the translation apparatus 10 determines a content indicated by the speech voice by using speech recognition processing of the first language La, further translates the content into the second language Lb of the second speaker Ub, and outputs voice via the speaker 6 (in the diagram, a flow indicated by an arrow of a broken line). The translation apparatus 10 translates, after recognizing in the second language Lb, the speech voice of the second speaker Ub input via the microphone 4 into the first language La of the first speaker Ua, and outputs the voice via the speaker 6 (in the diagram, a flow indicated by an arrow of a one-dot chain line).

However, interlingual translation is not limited to two directions, and may be in one direction. Moreover, an interpreter who can speak an inferred language may interpret without using the translation apparatus 10.

Further, the language inference apparatus 100 may infer not only a language of a speaker, but also a dialect or an accent of a residence of a speaker.

### Functional Configuration Example

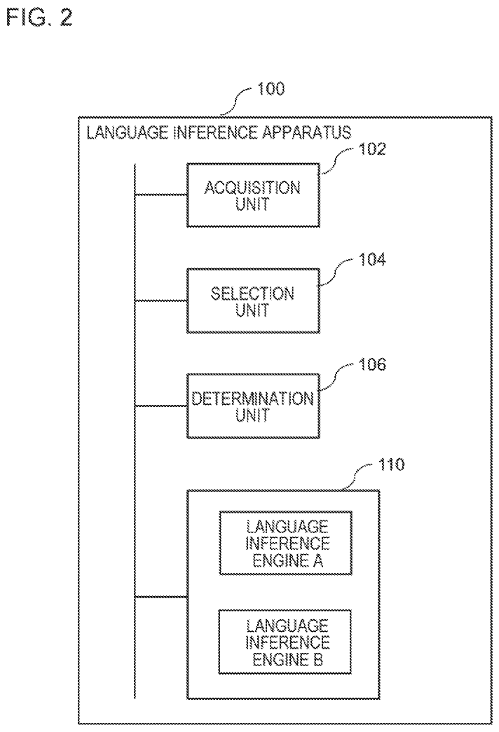

FIG. 2 is a functional block diagram logically illustrating a configuration of the language inference apparatus 100 according to an example embodiment of the present invention. The language inference apparatus 100 includes an acquisition unit 102, a selection unit 104, and a determination unit 106.

The acquisition unit 102 acquires nationality information.

The selection unit 104 selects a language inference engine 110 by using the acquired nationality information.

The determination unit 106 determines a language used by a speaker, by analyzing voice information 30 of the speaker using the selected language inference engine 110.

The acquisition unit 102 acquires, for example, nationality information from a passport 20 owned by a traveler. As one example, the acquisition unit 102 reads, via an IC reader (not illustrated), nationality information recorded in an integrated circuit (IC) embedded in the passport 20. In another example, the acquisition unit 102 acquires an image including a representation of a nationality described in the passport 20, processes the image by optical character recognition (OCR), and thereby reads a character. Moreover, even when the passport 20 does not include a representation of a nationality, nationality information may be acquired by reading a serial number including the nationality information described in the passport. In another example, a two-dimensional bar code recording nationality information described in the passport 20 is read by a bar code reader.

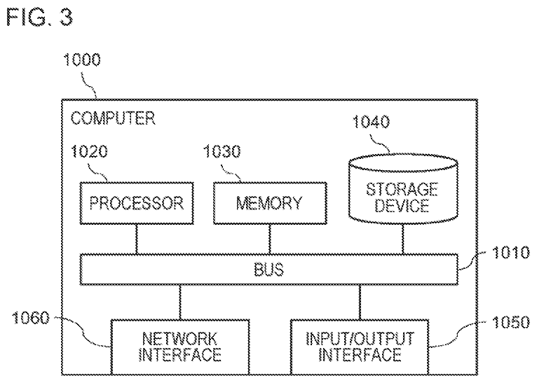

Furthermore, in another example, nationality information is determined by acquiring an image capturing a design (varying from country to country) of a cover or the like of the passport 20. Specifically, the language inference apparatus 100 previously registers a feature value of a design of the passport 20 of each country in a storage device 1040 in FIG. 3 (or may refer to an external database), and the acquisition unit 102 performs matching processing of the feature value by image processing of an image capturing the passport 20, determines a country, and acquires the country as nationality information.

Furthermore, the language inference apparatus 100 can also be applied, for example, to infer a language, a dialect, an accent, or the like of a passenger or a customer by an officer at a check-in counter of an airport, a baggage storage counter, or an information office or various kinds of windows of an airport, a railroad, or the like, or by an attendant or the like in an airplane, a passenger compartment, or a passenger car.

The acquisition unit 102 may acquire, for example, an image including description of a departure airport name described in a plane ticket owned by the first speaker Ua, or a boarding station name or the like in a boarding ticket of a vehicle such as a railroad, process the image by OCR, and thereby read a character. A country name or a prefecture name may be searched for and acquired from a depart airport name or a boarding station name. In an example of inferring a dialect or an accent, the language inference engine 110 specialized in each prefecture name is prepared.

The language inference engine 110 uses a speech voice of a speaker, and thereby infers what language a language of the speech voice is. In the present example embodiment, the language inference engine 110 is prepared on a country-by-country basis, and learned in such a way as to be specialized in each of a plurality of languages used on a country-by-country basis.

### Hardware Configuration Example

FIG. 3 is a block diagram illustrating a hardware configuration of a computer 1000 that achieves the language inference apparatus 100 illustrated in FIG. 2. The computer 1000 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function of the computer 1000. The processor 1020 reads each of the program modules onto the memory 1030, executes the read program module, and thereby achieves each function being relevant to the program module. Moreover, the storage device 1040 also stores the language inference engine 110.

The program module may be recorded in a storage medium. A storage medium recording the program module may include a medium usable by the non-transitory tangible computer 1000, and a program code readable by the computer 1000 (the processor 1020) may be embedded in the medium.

The input/output interface 1050 is an interface for connecting the computer 1000 to various kinds of input/output equipment.

The network interface 1060 is an interface for connecting the computer 1000 to a communication network. The communication network is, for example, a local area network (LAN) or a wide area network (WAN). A method of connecting the network interface 1060 to a communication network may be wireless connection or may be wired connection.

Then, the computer 1000 is connected to necessary equipment (e.g., a microphone 4 and a speaker 6) via the input/output interface 1050 or the network interface 1060.

The computer 1000 that achieves the language inference apparatus 100 is, for example, a smartphone, a tablet terminal, or the like. Alternatively, the computer 1000 that achieves the language inference apparatus 100 may be a dedicated terminal apparatus. As described above, the language inference apparatus 100 may be achieved by the computer 1000 physically integrated with the translation apparatus 10. For example, the language inference apparatus 100 is achieved by installing, in the computer 1000 an application program for achieving the language inference apparatus 100, and starting the application program.

In another example, the computer 1000 is a web server, and a user may be able to utilize a function of the language inference apparatus 100 by starting a browser on a user terminal such as a personal computer, a smartphone, or a tablet terminal, and accessing a web page providing a service of the language inference apparatus 100 via a network such as the Internet.

In still another example, the computer 1000 may be a server apparatus of a system such as Software as a Service (SaaS) providing a service of the language inference apparatus 100. A user may access the server apparatus from a user terminal such as a personal computer, a smartphone, or a tablet terminal via a network such as the Internet, and the language inference apparatus 100 may be achieved by a program operating on the server apparatus.

### Operation Example

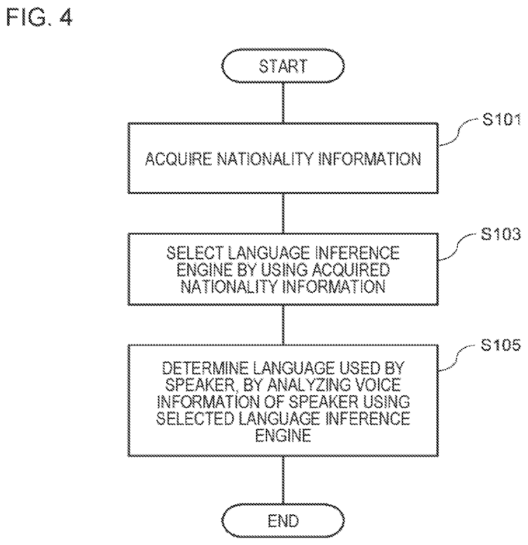

FIG. 4 is a flowchart illustrating one example of an operation of the language inference apparatus 100 according to the present example embodiment.

First, the acquisition unit 102 acquires nationality information from the passport 20 of the first speaker Ua (step S101).

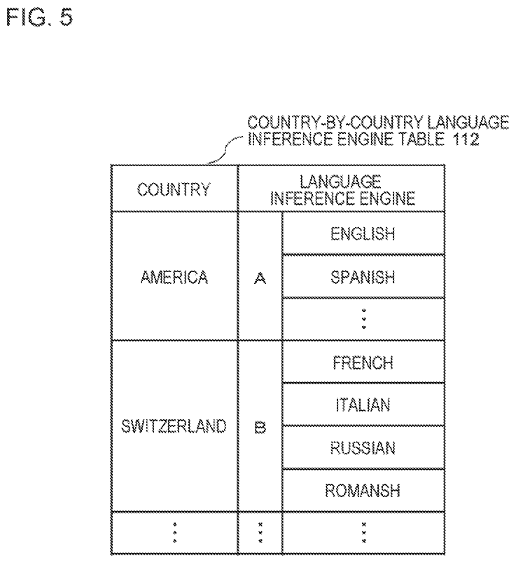

FIG. 5 is a diagram illustrating one example of a data structure of a country-by-country language inference engine table 112. The country-by-country language inference engine table 112 stores a language inference engine specialized for each country in an associated way. Note that, FIG. 5 illustrates in such a way that the country-by-country language inference engine table 112 stores “America”, “A”, “English”, and the like, for ease of understanding. Actually, the country-by-country language inference engine table 112 stores information indicating a country, for example, information identifying a country, and information identifying a language inference engine, in an associated way. Further, a language targeted for inference by each language inference engine is not stored in the country-by-country language inference engine table 112. FIG. 5 illustrates, for description, which language the language inference engine is specialized in as an inference target.

For example, a language inference engine A specialized in a plurality of languages such as English and Spanish is associated with America. A language inference engine B specialized in four languages of French, Italian, German, and Romansh is associated with Switzerland.

Then, the selection unit 104 refers to the country-by-country language inference engine table 112, reads the language inference engine 110 being associated with a country indicated by the nationality information acquired in step S101, and selects the language inference engine 110 to be used by the determination unit 106 (step S103). As one example, when a country indicated by the nationality information acquired in step S101 is America, the language inference engine A being associated with information indicating a country of America is selected from among a plurality of language inference engines previously stored in the country-by-country language inference engine table 112.

Then, the determination unit 106 acquires a speech voice of the first speaker Ua from the microphone 4, analyzes the voice information 30 of the speech voice by using the language inference engine A selected in step S103, and determines the first language La used by the first speaker Ua from among a plurality of languages such as English and Spanish (step S105). Herein, it is assumed that Spanish is determined by analyzing the voice information 30 of the speech voice of the first speaker Ua. In this way, since a language inference engine specialized on a country-by-country basis is used, the number of languages to be analysis targets of the voice information 30 can be narrowed down.

As described above, according to the present example embodiment, since the number of languages to be an analysis target is narrowed down and a language inference is performed by using the language inference engine 110 that is learned on a country-by-country basis by using nationality information acquired from the passport 20 or the like, language inference processing can be performed efficiently and accurately.

### Second Example Embodiment

A language inference apparatus 100 according to the present example embodiment differs from the example embodiment described above in having a configuration that infers a language by using a language inference engine 110 targeting a plurality of countries.

### Functional Configuration Example

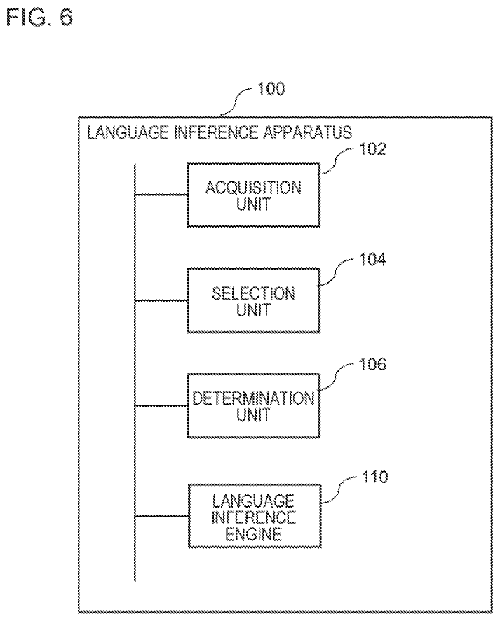

FIG. 6 is a functional block diagram illustrating a logical configuration example of the language inference apparatus 100 according to the present example embodiment. An acquisition unit 102 is the same as that in the example embodiment described above in FIG. 2.

A selection unit 104 selects candidates for a language of a language inference target, by using nationality information acquired by the acquisition unit 102. A determination unit 106 determines a language used by the speaker from among the selected candidates by using one language inference engine 110 targeting a plurality of countries and analyzing voice information of the speaker.

### Operation Example

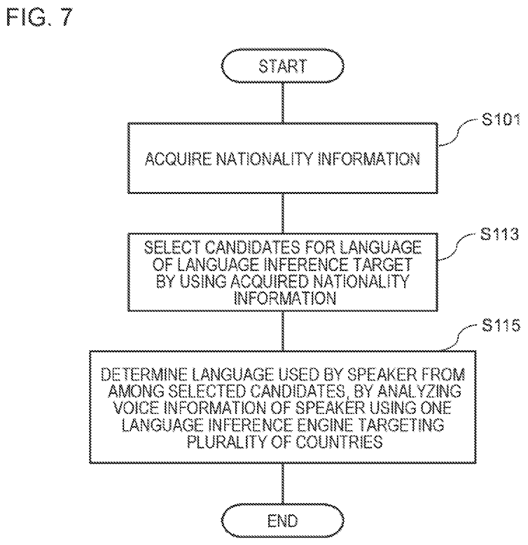

FIG. 7 is a flowchart illustrating one example of an operation of the language inference apparatus 100 according to the present example embodiment.

The flowchart in FIG. 7 includes the same step S101 as that in a flowchart according to the example embodiment described above in FIG. 4, and further includes steps S113 and S115.

The selection unit 104 selects a candidate for a language of a language inference target, by using nationality information acquired in step S101 (step S113).

The language inference engine 110 according to the present example embodiment builds, by deep learning, a neural network of all target languages (e.g., 50 languages) being relevant to all target countries (e.g., one hundred and several tens of countries). Input to the neural network is voice data, and output is a language.

In other words, the selection unit 104 narrows down a candidate by masking, by a country, a language of an output of the neural network of the language inference engine 110. For example, a candidate for a language is narrowed down by previously storing an output language on a country-by-country basis in an associated way, and deriving a logical product of an output language being associated with a country and an output language of the neural network.

Then, the determination unit 106 analyzes voice information of a speaker and determines a language used by the speaker, by using the language inference engine 110 in which a candidate for a language is narrowed down in this way (step S115).

The present example embodiment brings about an advantageous effect similar to that according to the example embodiment described above.

### Third Example Embodiment

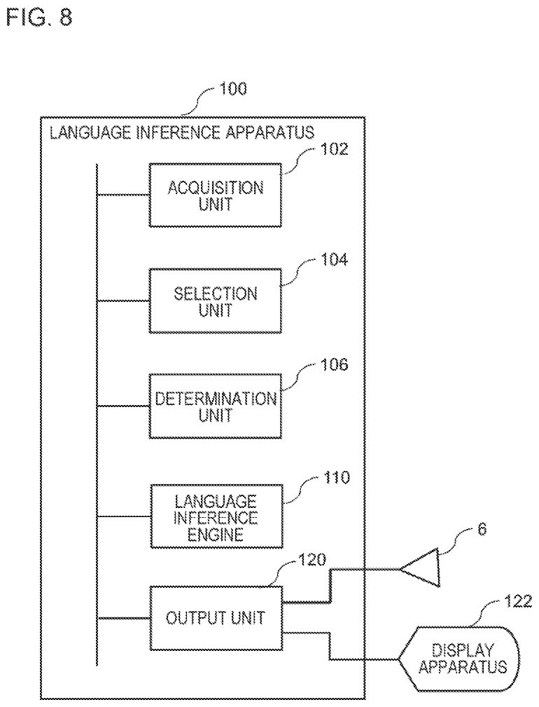

FIG. 8 is a functional block diagram illustrating a logical configuration example of a language inference apparatus 100 according to the present example embodiment. The language inference apparatus 100 according to the present example embodiment is the same as that according to any of the example embodiments described above, except that a configuration that presents an inferred language to a user is included.

### Functional Configuration Example

The language inference apparatus 100 in FIG. 8 includes an acquisition unit 102, a selection unit 104, a determination unit 106, and a language inference engine 110 that are the same as those in a language inference apparatus 100 according to the example embodiment described above in FIG. 2 or 6, and further includes an output unit 120.

When a score indicating a reliability degree of a language inference result using voice information of a speaker is equal to or less than a first criterion value, the output unit 120 outputs a voice or a character using the determined language. Herein, a score indicating a reliability degree of a language inference result may be, for example, a likelihood included in a result of performing speech recognition processing of voice information of a speaker. When a score indicating a reliability degree of a language inference result is lower than the first criterion value, the output unit 120 may output a voice or a character using the language in consideration of a possibility that the inference result is a mistake, and cause a speaker or an answerer to select. Assessment using a score may be performed by the determination unit 106. Moreover, when a score is more than the first criterion value, the determination unit 106 may determine on a language with the highest score.

The first criterion value is a criterion with which whether a result of language inference is reliable is assessed, and indicates that a reliability degree of a result of language inference is low when being equal to or less than the first criterion value, and or indicates that a result of language inference is reliable when being more than the first criterion value.

The output unit 120 outputs a voice to a speaker 6, or a character to a display apparatus 122. A question such as “Is a language you speak Hindi?” may be output by using a determined language.

The output unit 120 outputs a voice or a character using the language determined in order of score.

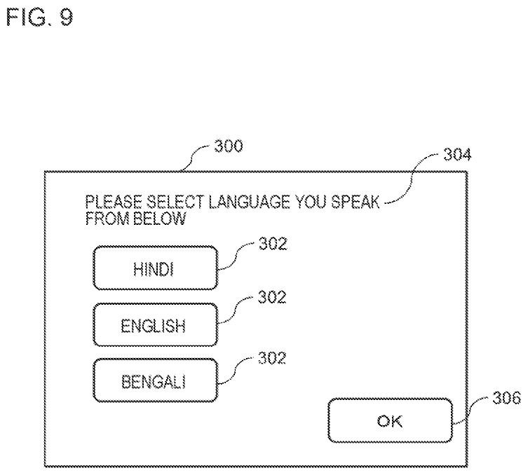

FIG. 9 is a diagram illustrating one example of a screen 300 displayed by the output unit 120. The screen 300 displays, as an operation button 302, each of a plurality of languages determined by the determination unit 106 in order of score, and displays a message 304 that urges a user to select a language. The screen 300 may be displayed, and a message may be output by a voice. Herein, the plurality of languages are preferably arranged and displayed in descending order of scores.

Note that, the operation button 302 and the message 304 are represented in Japanese for ease of description in FIG. 9, but, actually, are each represented in a determined language. After a language is selected by pressing the operation button 302, a language selection can be fixed by pressing an OK button 306. Moreover, each time a language is selected with the operation button 302, representation of the message 304 may be changed to the selected language.

An operation button is used as a graphical user interface (GUI) in the example of FIG. 9, but a GUI may be a check button, a radio button, a pull-down menu, a drum roll, or the like in another example. Alternatively, no UI for accepting a selection operation of a user may be used, and a plurality of languages and a question message to the user may be only displayed.

Furthermore, the output unit 120 does not output a voice or a character using a language with a score being equal to or less than a second criterion value. The second criterion value is a value lower than the first criterion value, and a value defining a range that hardly seems to have reliability. Thereby, a language for which a certain reliability degree is ensured can be presented to a user.

Furthermore, when a difference of scores between candidates is equal to or less than a third criterion value, the output unit 120 may output a voice or a language by using languages of the candidates, i.e., by using candidates whose degrees of certainty of language inference results are comparable. This assessment processing may also be performed by the determination unit 106. When a difference is more than the third criterion value, the determination unit 106 may determine on a language with the highest score.

The output unit 120 may perform at least one or at least any two of pieces of assessment processing using the first criterion value, the second criterion value, or the third criterion value, and can determine, based on a result of the assessment, whether to perform output of a voice or a language.

### Operation Example

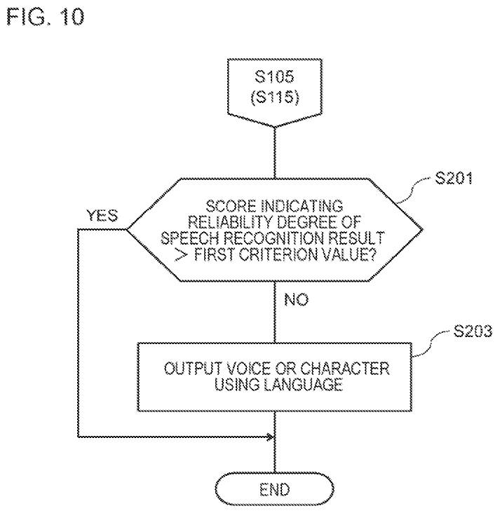

FIG. 10 is a flowchart illustrating an operation example of the language inference apparatus 100 according to the present example embodiment. A flow of FIG. 10 is started after step S105 in FIG. 4 or after step S115 in FIG. 7. The output unit 120 assesses whether a score indicating a reliability degree of a speech recognition result when voice information of a speaker is analyzed by using a plurality of languages selected in step S103 is equal to or less than the first criterion value (step S201). When a score is not equal to or less than the first criterion value (YES in step S201), the present flow is finished by bypassing step S203.

On the other hand, when a score is equal to or less than the first criterion value (NO in step S201), the output unit 120 outputs, from the speaker 6, a voice using the language, or display a character using the language on the display apparatus 122 (step S203).

According to the present example embodiment, when a score marking a reliability degree of a speech recognition result of a speaker by the language inference engine 110 is lower than the first criterion value, a voice or a character using the language is output. Thereby, the language inference apparatus 100 according to the present example embodiment brings about an advantageous effect similar to that according to the example embodiment described above, and can further cause a speaker or an answerer to confirm by a voice or a character, and accept selection of an appropriate language, when a reliability degree of an inference result is low.

While the example embodiments of the present invention have been described above with reference to the drawings, the example embodiments are illustrations of the example embodiments, and various configurations other than the above can also be adopted.

For example, when nationality information acquired by the acquisition unit 102 indicates a predetermined country, the selection unit 104 does not perform selection of the language inference engine 110, and the determination unit 106 determines a language being previously associated with the country.

Herein, regarding a unilingual country such as Japan with only Japanese, the country and a language are previously stored in a country-by-country language support table in an associated way. Then, the selection unit 104 first refers to the country-by-country language support table, searches the country-by-country language support table for a country indicated by nationality information acquired by the acquisition unit 102, and, when a country is found, acquires and outputs a language being associated with the country.

According to this configuration, since language inference processing using the language inference engine 110 can be omitted regarding a unilingual country, a load of a computer 1000 can be reduced, accuracy is further improved, and efficiency is high.

Moreover, the language inference apparatus 100 may further include a second selection unit (not illustrated) that selects a translation engine being relevant to a language determined by the determination unit 106. The second selection unit reports information on the selected translation engine to a translation apparatus 10 of a multilingual support communication system 1 in FIG. 1. The translation apparatus 10 can perform mutual translation between a first language La of a first speaker Ua and a second language Lb of a second speaker Ub, by using the reported translation engine.

While the invention of the present application has been described above with reference to the example embodiments and examples, the invention of the present application is not limited to the example embodiments and examples described above. Various modifications understandable to a person skilled in the art can be made to a configuration and details of the invention of the present application within the scope of the invention of the present application.

Note that, when information relating to a user is acquired and utilized in the present invention, the acquisition and utilization are to be performed legally.

Some or all of the above-described example embodiments can also be described as, but are not limited to, the following supplementary notes.

A supplementary note of an example of a reference embodiment is set forth below.

1. A language inference apparatus including:

an acquisition unit that acquires nationality information;

a selection unit that selects a language inference engine by using the acquired nationality information; and

a determination unit that determines a language used by a speaker, by analyzing voice information of the speaker using the selected language inference engine.

2. A language inference apparatus including:

an acquisition unit that acquires nationality information;

a selection unit that selects a candidate for a language of a language inference target by using the acquired nationality information; and

a determination unit that determines a language used by a speaker from the selected candidate, by analyzing voice information of the speaker using a language inference engine.

3. The language inference apparatus according to supplementary note 1 or 2, wherein

the acquisition unit acquires the nationality information from a passport.

4. The language inference apparatus according to any one of supplementary notes 1 to 3, further including

an output unit that outputs a voice or a character using the language determined by the determination unit, when a score indicating a reliability degree of a language inference result using the voice information of the speaker is equal to or less than a first criterion value.

5. The language inference apparatus according to supplementary note 4, wherein

the output unit outputs the voice or the character in order of the score.

6. The language inference apparatus according to supplementary note 4 or 5, wherein

the output unit does not output the voice or the character using the language with the score being equal to or less than a second criterion value.

7. The language inference apparatus according to any one of supplementary notes 1 to 6, further including

a second selection unit that selects a translation engine being relevant to the language determined by the determination unit.

8. The language inference apparatus according to any one of supplementary notes 1 to 7, wherein

when the nationality information acquired by the acquisition unit indicates a predetermined country, the selection unit does not perform selection of a language inference engine, and the determination unit determines a language being previously associated with the country.

9. A language inference method including:

by a language inference apparatus,

acquiring nationality information;

selecting a language inference engine by using the acquired nationality information; and

determining a language used by a speaker, by analyzing voice information of the speaker using the selected language inference engine.

10. A language inference method including:

by a language inference apparatus,

acquiring nationality information;

selecting a candidate for a language of a language inference target by using the acquired nationality information; and

determining a language used by a speaker from the selected candidate, by analyzing voice information of the speaker using a language inference engine.

11. The language inference method according to supplementary note 9 or 10, further including,

by the language inference apparatus,

acquiring the nationality information from a passport.

12. The language inference method according to any one of supplementary notes 9 to 11, further including,

by the language inference apparatus,

outputting a voice or a character using the determined language, when a score indicating a reliability degree of a language inference result using the voice information of the speaker is equal to or less than a first criterion value.

13. The language inference method according to supplementary note 12, further including,

by the language inference apparatus,

outputting the voice or the character in order of the score.

14. The language inference method according to supplementary note 12 or 13, further including,

by the language inference apparatus,

not outputting the voice or the character using the language with the score being equal to or less than a second criterion value.

15. The language inference method according to any one of supplementary notes 9 to 14, further including,

by the language inference apparatus,

selecting a translation engine being relevant to the determined language.

16. The language inference method according to any one of supplementary notes 9 to 15, further including,

by the language inference apparatus,

when the acquired nationality information indicates a predetermined country, not performing selection of a language inference engine, and determining a language being previously associated with the country.

17. A program for causing a computer to execute:

a procedure of acquiring nationality information;

a procedure of selecting a language inference engine by using the acquired nationality information; and

a procedure of determining a language used by a speaker, by analyzing voice information of the speaker using the selected language inference engine.

18. A program for causing a computer to execute:

a procedure of acquiring nationality information;

a procedure of selecting a candidate for a language of a language inference target by using the acquired nationality information; and

a procedure of determining a language used by a speaker from the selected candidate, by analyzing voice information of the speaker using a language inference engine.

19. The program according to supplementary note 17 or 18, for further causing a computer to execute

a procedure of acquiring the nationality information from a passport.

20. The program according to any one of supplementary notes 17 to 19, for further causing a computer to execute

a procedure of outputting a voice or a character using the determined language, when a score indicating a reliability degree of a language inference result using the voice information of the speaker is equal to or less than a first criterion value.

21. The program according to supplementary note 20, for further causing a computer to execute

a procedure of outputting the voice or the character in order of the score.

22. The program according to supplementary note 20 or 21, for further causing a computer to execute

a procedure of not outputting the voice or the character using the language with the score being equal to or less than a second criterion value.

23. The program according to any one of supplementary notes 17 to 22, for further causing a computer to execute

a procedure of selecting a translation engine being relevant to the determined language.

24. The program according to any one of supplementary notes 17 to 23, for further causing a computer to execute

a procedure of, when the acquired nationality information indicates a predetermined country, not performing selection of a language inference engine, and determining a language being previously associated with the country.

This application is based upon and claims the benefit of priority from Japanese patent application No. 2019-164404, filed on Sep. 10, 2019, the disclosure of which is incorporated herein in its entirety by reference.

### REFERENCE SIGNS LIST

1 Multilingual support communication system
4 Microphone
6 Speaker
10 Translation apparatus
20 Passport
30 Voice information
100 Language inference apparatus
102 Acquisition unit
104 Selection unit
106 Determination unit
110 Language inference engine
112 Country-by-country language inference engine table
120 Output unit
122 Display apparatus
300 Screen
302 Operation button
304 Message
306 OK button
1000 Computer
1010 Bus
1020 Processor
1030 Memory
1040 Storage device
1050 Input/output interface
1060 Network interface
La First language
Lb Second language
Ua First speaker
Ub Second speaker

What is claimed is:

1. A language inference apparatus comprising:
an acquisition unit that acquires nationality information;
a selection unit that selects a language inference engine by using the acquired nationality information; and
a determination unit that determines a language used by a speaker, by analyzing voice information of the speaker using the selected language inference engine.

2. (canceled)

3. The language inference apparatus according to claim 1, wherein
the acquisition unit acquires the nationality information from a passport.

4. The language inference apparatus according to claim 1, further comprising
an output unit that outputs a voice or a character using the language determined by the determination unit, when a score indicating a reliability degree of a language inference result using the voice information of the speaker is equal to or less than a first criterion value.

5. The language inference apparatus according to claim 4, wherein
the output unit outputs the voice or the character in order of the score.

6. The language inference apparatus according to claim 4, wherein
the output unit does not output the voice or the character using the language with the score being equal to or less than a second criterion value.

7. The language inference apparatus according to claim 1, further comprising
a second selection unit that selects a translation engine being relevant to the language determined by the determination unit.

8. The language inference apparatus according to claim 1, wherein,
when the nationality information acquired by the acquisition unit indicates a predetermined country, the selection unit does not perform selection of a language inference engine, and the determination unit determines a language being previously associated with the country.

9. A language inference method comprising:
by a language inference apparatus,
acquiring nationality information;
selecting a language inference engine by using the acquired nationality information; and
determining a language used by a speaker, by analyzing voice information of the speaker using the selected language inference engine.

10.-16. (canceled)

17. A non-transitory computer-readable storage medium storing a program for causing a computer to execute:
a procedure of acquiring nationality information;
a procedure of selecting a language inference engine by using the acquired nationality information; and
a procedure of determining a language used by a speaker, by analyzing voice information of the speaker using the selected language inference engine.
